(19) United States
(12) Patent Application Publication
(10) Pub. No.: US 2018/0364728 A1
(43) Pub. Date: Dec. 20, 2018

(54) SYSTEMS AND METHODS FOR VEHICLE CLEANING

(71) Applicant: GM GLOBAL TECHNOLOGY OPERATIONS LLC, Detroit, MI (US)

(72) Inventors: VALOR YALDO, WEST BLOOMFIELD, MI (US); XIAOFENG F. SONG, NOVI, MI (US)

(73) Assignee: GM GLOBAL TECHNOLOGY OPERATIONS LLC, Detroit, MI (US)

(21) Appl. No.: 15/627,307

(22) Filed: Jun. 19, 2017

(51) Int. Cl. G05D 1/02; G05D 1/00; G01C 21/36; G06K 9/00; G06K 9/46

(52) U.S. Cl. CPC G05D 1/0225; G05D 1/0088; G06K 9/4652; G06K 9/00832; G01C 21/3679

(57) ABSTRACT

Systems and methods are provided for controlling an autonomous vehicle. In one embodiment, a method includes: receiving image data from a camera device coupled to the autonomous vehicle; computing, by a processor, a value based on the image data; determining, by a processor, one of a cleanliness and an uncleanliness of the autonomous vehicle based on the computed value; and selectively generating, by a processor, a signal to at least one of control the autonomous vehicle to navigate to a cleaning station and notify a user based on the determined one of cleanliness and uncleanliness of the autonomous vehicle.

### TECHNICAL FIELD

The present disclosure generally relates to autonomous vehicles, and more particularly relates to systems and methods for determining when the autonomous vehicle needs to be washed and controlling the autonomous vehicle based thereon.

### INTRODUCTION

An autonomous vehicle is a vehicle that is capable of sensing its environment and navigating with little or no user input. An autonomous vehicle senses its environment using sensing devices such as radar, lidar, image sensors, and the like. The autonomous vehicle system further uses information from global positioning systems (GPS) technology, navigation systems, vehicle-to-vehicle communication, vehicle-to-infrastructure technology, and/or drive-by-wire systems to navigate the vehicle.

Vehicle automation has been categorized into numerical levels ranging from Zero, corresponding to no automation with full human control, to Five, corresponding to full automation with no human control. Various automated driver-assistance systems, such as cruise control, adaptive cruise control, and parking assistance systems correspond to lower automation levels, while true “driverless” vehicles correspond to higher automation levels.

In some instances, an autonomous vehicle may not have a dedicated owner to monitor the overall cleanliness of the vehicle. For example, if the autonomous vehicle is part of a fleet of vehicles that carry passengers from one location to another, the autonomous vehicle may not be viewed regularly by an owner. Thus, any uncleanliness of the vehicle may go undetected.

Accordingly, it is desirable to provide systems and methods that for determining when the autonomous vehicle needs to be washed and controlling the autonomous vehicle based thereon. Furthermore, other desirable features and characteristics of the present invention will become apparent from the subsequent detailed description and the appended claims, taken in conjunction with the accompanying drawings and the foregoing technical field and background.

### SUMMARY

Systems and methods are provided for controlling an autonomous vehicle. In one embodiment, a method includes: receiving image data from a camera device coupled to the autonomous vehicle; computing, by a processor, a value based on the image data; determining, by a processor, at least one of a cleanliness and an uncleanliness of the autonomous vehicle based on the computed value; and selectively generating, by a processor, a signal to at least one of control the autonomous vehicle to navigate to a cleaning station and notify a user based on the determined at least one of cleanliness and uncleanliness of the autonomous vehicle.

### BRIEF DESCRIPTION OF THE DRAWINGS

The exemplary embodiments will hereinafter be described in conjunction with the following drawing figures, wherein like numerals denote like elements, and wherein:

FIG. 1A is a functional block diagram illustrating an autonomous vehicle having a cleaning system, in accordance with various embodiments;

FIG. 1B is an illustration of vehicle cameras of the cleaning system distributed about the autonomous vehicle, in accordance with various embodiments;

FIG. 2 is a functional block diagram illustrating a transportation system having one or more autonomous vehicles of FIG. 1A, in accordance with various embodiments; and

FIG. 3 is a functional block diagram illustrating an autonomous driving system having a cleaning system of the vehicle of FIG. 1A, in accordance with various embodiments;

FIG. 4 is a flowchart illustrating a control method for controlling the autonomous vehicle, in accordance with various embodiments.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description. As used herein, the term module refers to any hardware, software, firmware, electronic control component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present disclosure may be practiced in conjunction with any number of systems, and that the systems described herein is merely exemplary embodiments of the present disclosure.

For the sake of brevity, conventional techniques related to signal processing, data transmission, signaling, control, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the present disclosure.

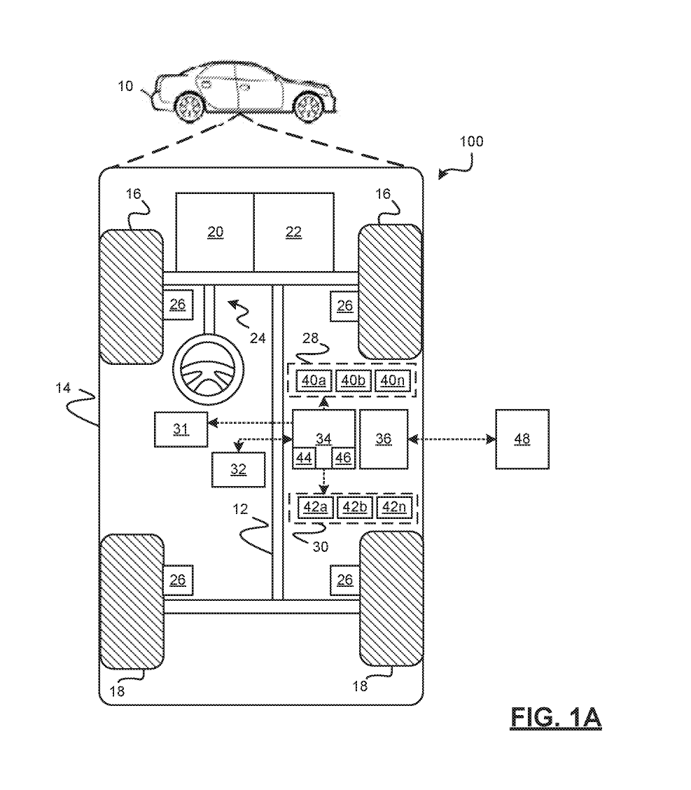

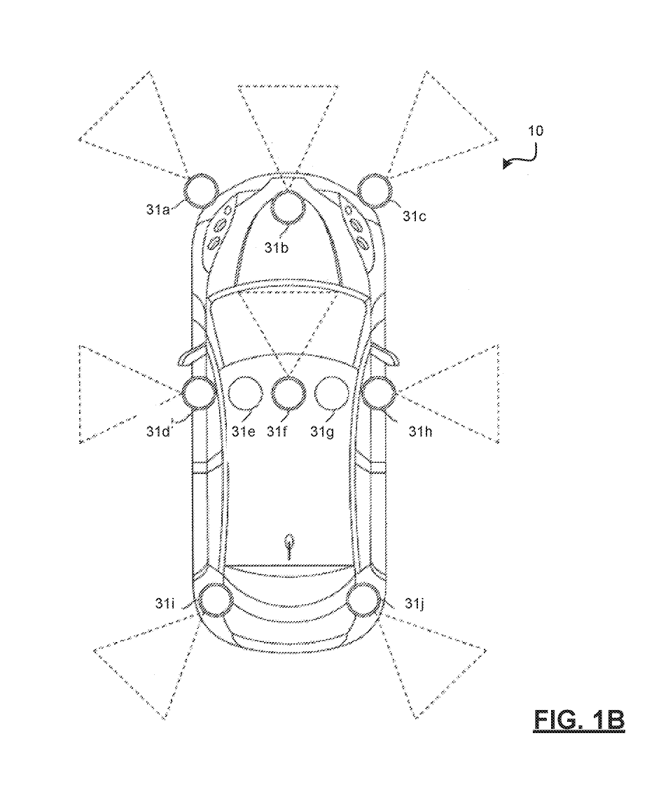

With reference to FIG. 1A, a cleaning system shown generally at 100 is associated with a vehicle 10 in accordance with various embodiments. In general, the cleaning system 100 receives sensor data from integrated sensors, detects an uncleanliness of the vehicle, generates warning messages about the uncleanliness and/or controls the vehicle 10 based on the uncleanliness.

As depicted in FIG. 1A, the vehicle 10 generally includes a chassis 12, a body 14, front wheels 16, and rear wheels 18. The body 14 is arranged on the chassis 12 and substantially encloses components of the vehicle 10. The body 14 and the chassis 12 may jointly form a frame. The wheels 16-18 are each rotationally coupled to the chassis 12 near a respective corner of the body 14.

In various embodiments, the vehicle 10 is an autonomous vehicle and the cleaning system 100 is incorporated into the autonomous vehicle 10 (hereinafter referred to as the autonomous vehicle 10). The autonomous vehicle 10 is, for example, a vehicle that is automatically controlled to carry passengers from one location to another. The vehicle 10 is depicted in the illustrated embodiment as a passenger car, but it should be appreciated that any other vehicle including motorcycles, trucks, sport utility vehicles (SUVs), recreational vehicles (RVs), marine vessels, aircraft, etc., can also be used. In an exemplary embodiment, the autonomous vehicle 10 is a so-called Level Four or Level Five automation system. A Level Four system indicates “high automation”, referring to the driving mode-specific performance by an automated driving system of all aspects of the dynamic driving task, even if a human driver does not respond appropriately to a request to intervene. A Level Five system indicates “full automation”, referring to the full-time performance by an automated driving system of all aspects of the dynamic driving task under all roadway and environmental conditions that can be managed by a human driver.

As shown, the autonomous vehicle 10 generally includes a propulsion system 20, a transmission system 22, a steering system 24, a brake system 26, a sensor system 28, an actuator system 30, at least one data storage device 32, at least one controller 34, and a communication system 36. The propulsion system 20 may, in various embodiments, include an internal combustion engine, an electric machine such as a traction motor, and/or a fuel cell propulsion system. The transmission system 22 is configured to transmit power from the propulsion system 20 to the vehicle wheels 16-18 according to selectable speed ratios. According to various embodiments, the transmission system 22 may include a step-ratio automatic transmission, a continuously-variable transmission, or other appropriate transmission. The brake system 26 is configured to provide braking torque to the vehicle wheels 16-18. The brake system 26 may, in various embodiments, include friction brakes, brake by wire, a regenerative braking system such as an electric machine, and/or other appropriate braking systems. The steering system 24 influences a position of the of the vehicle wheels 16-18. While depicted as including a steering wheel for illustrative purposes, in some embodiments contemplated within the scope of the present disclosure, the steering system 24 may not include a steering wheel.

The sensor system 28 includes one or more sensing devices 40a-40n that sense observable conditions of the exterior environment and/or the interior environment of the autonomous vehicle 10. The sensing devices 40a-40n can include, but are not limited to, radars, lidars, global positioning systems, optical cameras, thermal cameras, ultrasonic sensors, inertial measurement units, and/or other sensors. The actuator system 30 includes one or more actuator devices 42a-42n that control one or more vehicle features such as, but not limited to, the propulsion system 20, the transmission system 22, the steering system 24, and the brake system 26. In various embodiments, the vehicle features controlled by the one or more actuator devices 42a-42n can further include interior and/or exterior vehicle features such as, but are not limited to, doors, a trunk, and cabin features such as air, music, lighting, etc. (not numbered).

In various embodiments, the sensor system 28 includes camera or other imaging devices 31, hereinafter referred to as camera devices 31. The camera devices 31 are coupled to an exterior of the body 14 of the vehicle 10 and/or coupled to an interior of the vehicle 10 such that they may capture images of the exterior of the vehicle 10 in addition to images of the environment surrounding the vehicle 10. For example, the camera devices 31 can include front cameras that include the engine bay hood in their field of view or surround vision cameras that include parts of the vehicle's body in their field of view. The images of the exterior of the vehicle 10 are used by the cleaning system 100 and the images of the environment are used by an autonomous driving system.

As shown, the camera devices 31 are selectively located throughout the vehicle 10 such that one or a certain set of camera devices 31 are selected to capture images of parts of the exterior body of the vehicle 10. For example, an exemplary embodiment of camera devices 31 distributed about the vehicle 10 is shown in FIG. 1B. As shown, camera devices 31a-31j (or any number of camera devices 31) are disposed at different locations and oriented to sense different portions of the surrounding environment in the vicinity of the vehicle 10. As can be appreciated, the camera devices 31a-31j can be all of the same type of camera device or be a combination of any of the types of camera devices. In the provided example, a first camera device 31a is positioned at the front left (or driver) side of the vehicle 10 and is oriented 45° counterclockwise relative to the longitudinal axis of the vehicle 10 in the forward direction, and another camera device 31c may be positioned at the front right (or passenger) side of the vehicle 10 and is oriented 45° clockwise relative to the longitudinal axis of the vehicle 10. Additional camera devices 31i, 31j are positioned at the rear left and right sides of the vehicle 10 and are similarly oriented at 45° counterclockwise and clockwise relative to the vehicle longitudinal axis, along with camera devices 31d and 31h positioned on the left and right sides of the vehicle 10 and oriented away from the longitudinal axis so as to extend along an axis that is substantially perpendicular to the vehicle longitudinal axis. The illustrated embodiment also includes a group of camera devices 31e-31g positioned at or near the vehicle longitudinal axis and oriented to provide forward direction signals in line with the vehicle longitudinal axis.

In various embodiments, side camera devices 31d and 31h have a wide field of view or are oriented in a manner to capture a portion of the vehicle body, and camera device 31f captures a hood of the vehicle body. These camera devices 31d, 31h, and 31f can provide sufficient images to evaluate the cleanliness of the exterior of the vehicle.

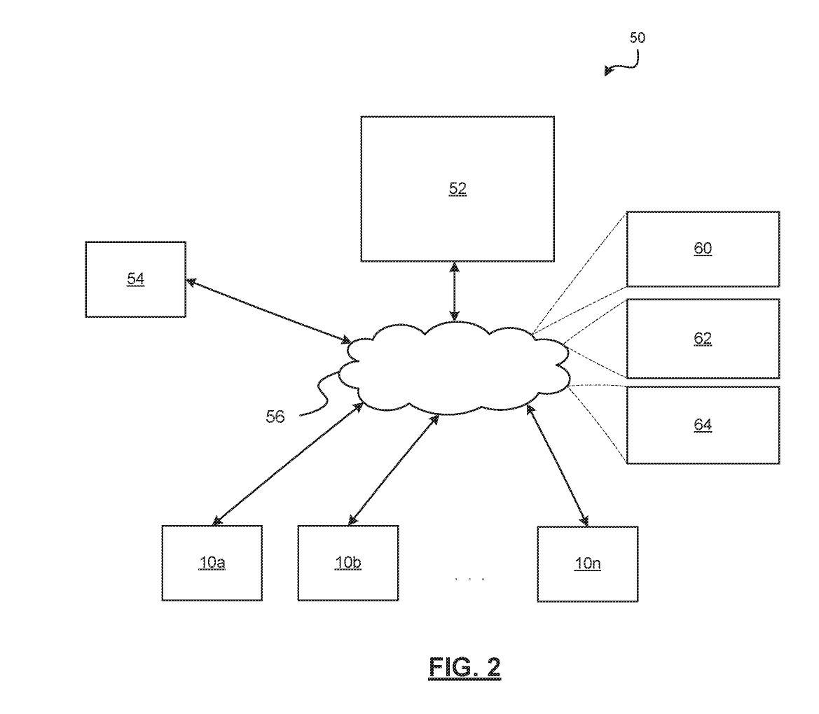

With reference to FIG. 1A, the communication system 36 is configured to wirelessly communicate information to and from other entities 48, such as but not limited to, other vehicles (“V2V” communication,) infrastructure (“V2I” communication), remote systems, and/or personal devices (described in more detail with regard to FIG. 2). In an exemplary embodiment, the communication system 36 is a wireless communication system configured to communicate via a wireless local area network (WLAN) using IEEE 802.11 standards or by using cellular data communication. However, additional or alternate communication methods, such as a dedicated short-range communications (DSRC) channel, are also considered within the scope of the present disclosure. DSRC channels refer to one-way or two-way short-range to medium-range wireless communication channels specifically designed for automotive use and a corresponding set of protocols and standards.

The data storage device 32 stores data for use in automatically controlling the autonomous vehicle 10. In various embodiments, the data storage device 32 stores defined maps of the navigable environment. In various embodiments, the defined maps may be predefined by and obtained from a remote system (described in further detail with regard to FIG. 2). For example, the defined maps may be assembled by the remote system and communicated to the autonomous vehicle 10 (wirelessly and/or in a wired manner) and stored in the data storage device 32. As can be appreciated, the data storage device 32 may be part of the controller 34, separate from the controller 34, or part of the controller 34 and part of a separate system.

The controller 34 includes at least one processor 44 and a computer readable storage device or media 46. The processor 44 can be any custom made or commercially available processor, a central processing unit (CPU), a graphics processing unit (GPU), an auxiliary processor among several processors associated with the controller 34, a semiconductor based microprocessor (in the form of a microchip or chip set), a macroprocessor, any combination thereof, or generally any device for executing instructions. The computer readable storage device or media 46 may include volatile and nonvolatile storage in read-only memory (ROM), random-access memory (RAM), and keep-alive memory (KAM), for example. KAM is a persistent or non-volatile memory that may be used to store various operating variables while the processor 44 is powered down. The computer-readable storage device or media 46 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 34 in controlling the autonomous vehicle 10.

The instructions may include one or more separate programs, each of which comprises an ordered listing of executable instructions for implementing logical functions. The instructions, when executed by the processor 44, receive and process signals from the sensor system 28, perform logic, calculations, methods and/or algorithms for automatically controlling the components of the autonomous vehicle 10, and generate control signals to the actuator system 30 to automatically control the components of the autonomous vehicle 10 based on the logic, calculations, methods, and/or algorithms. Although only one controller 34 is shown in FIG. 1A, embodiments of the autonomous vehicle 10 can include any number of controllers 34 that communicate over any suitable communication medium or a combination of communication mediums and that cooperate to process the sensor signals, perform logic, calculations, methods, and/or algorithms, and generate control signals to automatically control features of the autonomous vehicle 10.

In various embodiments, one or more instructions of the controller 34 are embodied in the cleaning system 100 and, when executed by the processor 44, receive image data from the camera devices 31, process the image data to verify camera lens clarity and/or determine an uncleanliness of the vehicle body, and/or to control the vehicle based on the determined clarity and/or uncleanliness. In various embodiments, the instructions, when executed by the processor 44 control the vehicle 10 to navigate to a vehicle cleaning station.

With reference now to FIG. 2, in various embodiments, the autonomous vehicle 10 described with regard to FIG. 1A may be suitable for use in the context of a taxi or shuttle system in a certain geographical area (e.g., a city, a school or business campus, a shopping center, an amusement park, an event center, or the like) or may simply be managed by a remote system. For example, the autonomous vehicle 10 may be associated with an autonomous vehicle based remote transportation system. FIG. 2 illustrates an exemplary embodiment of an operating environment shown generally at 50 that includes an autonomous vehicle based remote transportation system 52 that is associated with one or more autonomous vehicles 10a-10n as described with regard to FIG. 1A. In various embodiments, the operating environment 50 further includes one or more user devices 54 that communicate with the autonomous vehicle 10 and/or the remote transportation system 52 via a communication network 56.

The communication network 56 supports communication as needed between devices, systems, and components supported by the operating environment 50 (e.g., via tangible communication links and/or wireless communication links). For example, the communication network 56 can include a wireless carrier system 60 such as a cellular telephone system that includes a plurality of cell towers (not shown), one or more mobile switching centers (MSCs) (not shown), as well as any other networking components required to connect the wireless carrier system 60 with a land communications system. Each cell tower includes sending and receiving antennas and a base station, with the base stations from different cell towers being connected to the MSC either directly or via intermediary equipment such as a base station controller. The wireless carrier system 60 can implement any suitable communications technology, including for example, digital technologies such as CDMA (e.g., CDMA2000), LTE (e.g., 4G LTE or 5G LTE), GSM/GPRS, or other current or emerging wireless technologies. Other cell tower/base station/MSC arrangements are possible and could be used with the wireless carrier system 60. For example, the base station and cell tower could be co-located at the same site or they could be remotely located from one another, each base station could be responsible for a single cell tower or a single base station could service various cell towers, or various base stations could be coupled to a single MSC, to name but a few of the possible arrangements.

Apart from including the wireless carrier system 60, a second wireless carrier system in the form of a satellite communication system 64 can be included to provide uni-directional or bi-directional communication with the autonomous vehicles 10a-10n. This can be done using one or more communication satellites (not shown) and an uplink transmitting station (not shown). Uni-directional communication can include, for example, satellite radio services, wherein programming content (news, music, etc.) is received by the transmitting station, packaged for upload, and then sent to the satellite, which broadcasts the programming to subscribers. Bi-directional communication can include, for example, satellite telephony services using the satellite to relay telephone communications between the vehicle 10 and the station. The satellite telephony can be utilized either in addition to or in lieu of the wireless carrier system 60.

A land communication system 62 may further be included that is a conventional land-based telecommunications network connected to one or more landline telephones and connects the wireless carrier system 60 to the remote transportation system 52. For example, the land communication system 62 may include a public switched telephone network (PSTN) such as that used to provide hardwired telephony, packet-switched data communications, and the Internet infrastructure. One or more segments of the land communication system 62 can be implemented through the use of a standard wired network, a fiber or other optical network, a cable network, power lines, other wireless networks such as wireless local area networks (WLANs), or networks providing broadband wireless access (BWA), or any combination thereof. Furthermore, the remote transportation system 52 need not be connected via the land communication system 62, but can include wireless telephony equipment so that it can communicate directly with a wireless network, such as the wireless carrier system 60.

Although only one user device 54 is shown in FIG. 2, embodiments of the operating environment 50 can support any number of user devices 54, including multiple user devices 54 owned, operated, or otherwise used by one person. Each user device 54 supported by the operating environment 50 may be implemented using any suitable hardware platform. In this regard, the user device 54 can be realized in any common form factor including, but not limited to: a desktop computer; a mobile computer (e.g., a tablet computer, a laptop computer, or a netbook computer); a smartphone; a video game device; a digital media player; a piece of home entertainment equipment; a digital camera or video camera; a wearable computing device (e.g., smart watch, smart glasses, smart clothing); or the like. Each user device 54 supported by the operating environment 50 is realized as a computer-implemented or computer-based device having the hardware, software, firmware, and/or processing logic needed to carry out the various techniques and methodologies described herein. For example, the user device 54 includes a microprocessor in the form of a programmable device that includes one or more instructions stored in an internal memory structure and applied to receive binary input to create binary output. In some embodiments, the user device 54 includes a GPS module capable of receiving GPS satellite signals and generating GPS coordinates based on those signals. In other embodiments, the user device 54 includes cellular communications functionality such that the device carries out voice and/or data communications over the communication network 56 using one or more cellular communications protocols, as are discussed herein. In various embodiments, the user device 54 includes a visual display, such as a touch-screen graphical display, or other display.

The remote transportation system 52 includes one or more backend server systems, which may be cloud-based, network-based, or resident at the particular campus or geographical location serviced by the remote transportation system 52. The remote transportation system 52 can be manned by a live advisor, or an automated advisor, or a combination of both. The remote transportation system 52 can communicate with the user devices 54 and the autonomous vehicles 10a-10n to schedule rides, dispatch autonomous vehicles 10a-10n, and the like. In various embodiments, the remote transportation system 52 stores account information such as subscriber authentication information, vehicle identifiers, profile records, behavioral patterns, and other pertinent subscriber information.

In accordance with a typical use case workflow, a registered user of the remote transportation system 52 can create a ride request via the user device 54. The ride request will typically indicate the passenger's desired pickup location (or current GPS location), the desired destination location (which may identify a predefined vehicle stop and/or a user-specified passenger destination), and a pickup time. The remote transportation system 52 receives the ride request, processes the request, and dispatches a selected one of the autonomous vehicles 10a-10n (when and if one is available) to pick up the passenger at the designated pickup location and at the appropriate time. The remote transportation system 52 can also generate and send a suitably configured confirmation message or notification to the user device 54, to let the passenger know that a vehicle is on the way.

As can be appreciated, the subject matter disclosed herein provides certain enhanced features and functionality to what may be considered as a standard or baseline autonomous vehicle 10 and/or an autonomous vehicle based remote transportation system 52. To this end, an autonomous vehicle and autonomous vehicle based remote transportation system can be modified, enhanced, or otherwise supplemented to provide the additional features described in more detail below.

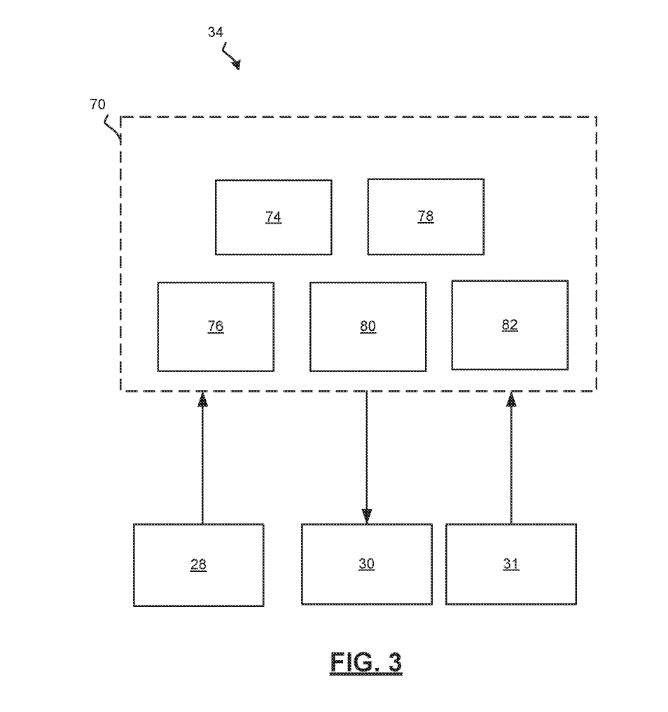

In accordance with various embodiments, the controller 34 implements an autonomous driving system (ADS) 70 as shown in FIG. 3. That is, suitable software and/or hardware components of controller 34 (e.g., processor 44 and computer-readable storage device 46) are utilized to provide an autonomous driving system 70 that is used in conjunction with vehicle 10.

In various embodiments, the instructions of the autonomous driving system 70 may be organized by function or system. For example, as shown in FIG. 3, the autonomous driving system 70 can include a computer vision system 74, a positioning system 76, a guidance system 78, and a vehicle control system 80. As can be appreciated, in various embodiments, the instructions may be organized into any number of systems (e.g., combined, further partitioned, etc.) as the disclosure is not limited to the present examples.

In various embodiments, the computer vision system 74 synthesizes and processes sensor data from the sensing devices 40a-40n (FIG. 1A) and predicts the presence, location, classification, and/or path of objects and features of the environment of the vehicle 10. In various embodiments, the computer vision system 74 can incorporate information from multiple sensors, including but not limited to cameras, lidars, radars, and/or any number of other types of sensors.

The positioning system 76 processes sensor data along with other data to determine a position (e.g., a local position relative to a map, an exact position relative to lane of a road, vehicle heading, velocity, etc.) of the vehicle 10 relative to the environment. The guidance system 78 processes sensor data along with other data to determine a path for the vehicle 10 to follow. The vehicle control system 80 generates control signals for controlling the vehicle 10 according to the determined path.

In various embodiments, the controller 34 implements machine learning techniques to assist the functionality of the controller 34, such as feature detection/classification, obstruction mitigation, route traversal, mapping, sensor integration, ground-truth determination, and the like.

As mentioned briefly above, a certain portion of the cleaning system 100 of FIG. 1A is included within the ADS 70, for example, as the cleaning system 82. In various embodiments, the cleaning system 82 communicates with the computer vision system 74, the guidance system 78, and/or the vehicle control system 80 to receive image data from the camera devices 31, process the image data to verify camera lens clarity and/or determine an uncleanliness/cleanliness of the vehicle body 14, and/or control the vehicle 10 based on the determined clarity and/or uncleanliness/cleanliness.

For example, the computer vision system 74 provides to the cleaning system 82 image data from the camera devices 31. In various embodiments, the cleaning system 82 processes the image data to evaluate pixels associated with the body 14 of the vehicle 10, compute a color (Red, Green, Blue) value associated with the pixels, and determine an uncleanliness/cleanliness based on the color value. For example, the color value is compared to a color value associated with a clean vehicle to determine if the uncleanliness/cleanliness. In various embodiments, the cleaning system 82 further processes the image data to determine a change in brightness of the pixels over a time period, and determines a clarity or blockage of a camera device 31 that generated the image data based on the change in brightness.

In another example, the cleaning system 82 communicates a recommendation to travel to a cleaning station to the guidance system 78. The guidance system 78, in turn, determines a route to the cleaning station and/or communicates notification messages to the transportation system 52 and/or users of the vehicle 10. In still another example, the cleaning system 82 communicates with the vehicle control system 80 directly to control one or more of the actuator devices of the actuator system 30 to cause the vehicle 10 to be controlled such that it autonomously navigates to a cleaning station.

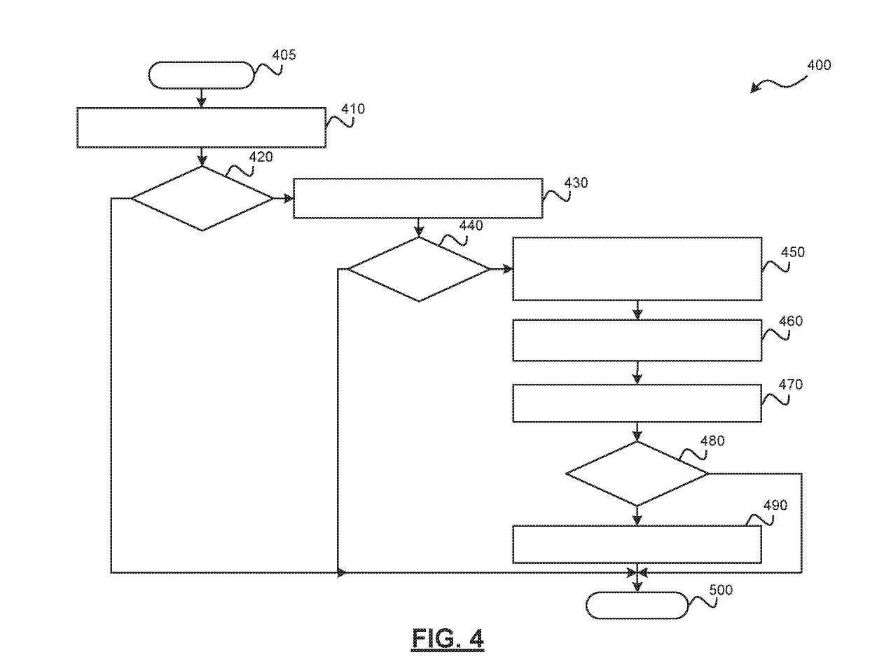

As shown in more detail with regard to FIG. 4 and with continued reference to FIGS. 1A, 1B, and 3, a flowchart illustrates a control method 400 that can be performed by the cleaning system 82 of FIG. 3 in accordance with the present disclosure. As can be appreciated in light of the disclosure, the order of operation within the method is not limited to the sequential execution as illustrated in FIG. 4, but may be performed in one or more varying orders as applicable and in accordance with the present disclosure. In various embodiments, the method 400 can be scheduled to run based on one or more predetermined events, and/or can run continuously during operation of the autonomous vehicle 10.

In various embodiments, the control method combines two methods of determining a cleanliness or uncleanliness of the autonomous vehicle. For example, the uncleanliness or cleanliness can be determined based on an obstruction of a lens of one of the camera devices 31 and/or dirt on the surface of the autonomous vehicle 10 that alters a RGB value. As can be appreciated, the methods can be implemented together as shown, separately, or as only one of the two methods to determine the cleanliness or uncleanliness of the autonomous vehicle 10.

In one example, the method may begin at 405. Image data is received from the camera devices 31 at 410. Brightness values are computed for each pixel in the image data at 420. The brightness values are then evaluated at 430. For example, if a number X of pixels have a brightness value of less than a defined threshold or a brightness sensitivity (or variation) across pixels (adjacent or non-adjacent) exists at 430, it is determined that the camera device 31 that generated the image data is blocked or lacks clarity (for example due to dirt being on the lens) at 440; and signals are generated to navigate the autonomous vehicle 10 to a cleaning station and/or present notifications to, for example, a user or the remote system 52 at 450. Thereafter, the method may end at 460.

If, however, the brightness values for less than X number of pixels are above the defined threshold at 430, then the camera device 31 that generated the image data is determined to be not blocked or clear and the image data is further processed at 470.

At 470, the image data is processed to extract pixels corresponding to the vehicle's body 14. For example, pixel locations that correspond to the body 14 may be predefined based on the camera device's configured location with respect to the body 14. A RGB value is computed for each pixel in the defined pixel locations; and a delta is computed between all of the pixels computed RGB values.

Thereafter, the delta is compared to a stored delta associated with a color of the body 14. In various embodiments, the stored delta may be initially sensed and stored as discussed above when it is known that the vehicle 10 is clean. As can be appreciated, the stored delta may be updated over time to account for fade or discoloration of the vehicle body 14 due, for example, to environmental exposure. If, at 480, the RGB values are different than (or not within a range of) the stored values, it is determined that the vehicle 10 is unclean at 490; and signals are generated to navigate the autonomous vehicle 10 to a cleaning station and/or present notifications to, for example, a user or remote system 52 at 450. Thereafter, the method may end at 460. If, however, the RGB values are the same as (or within a range of) the stored values, it is determined that the vehicle 10 is clean at 500; and the method may end a 460.

As can be appreciated, in various embodiments, steps 420 to 500 may loop for each camera device 31 on the vehicle 10 and only generate the signals at 450 when a certain number N of camera devices 3 are blocked or determine that the vehicle 10 is unclean.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method of controlling an autonomous vehicle, comprising:
receiving image data from a camera device coupled to the autonomous vehicle;
computing, by a processor, a value based on the image data;
determining, by a processor, one of a cleanliness and an uncleanliness of the
autonomous vehicle based on the computed value; and
selectively generating, by a processor, a signal to at least one of control the autonomous vehicle to navigate to a cleaning station and notify a user based on the determined one of cleanliness and uncleanliness of the autonomous vehicle.

2. The method of claim 1, wherein the computing the value comprises computing a color value based on the image data.

3. The method of claim 2, wherein the color value is a Red, Green, Blue value.

4. The method of claim 2, wherein the determining the one of the cleanliness and the uncleanliness of the autonomous vehicle is based on a comparison of the color value to a stored value associated with a body of the vehicle.

5. The method of claim 1, wherein the computing the color value comprises computing a color value for a plurality of pixels in the image data, and wherein the determining the one of the cleanliness and the uncleanliness of the autonomous vehicle is based on a comparison of the color values for the plurality of pixels to a threshold.

6. The method of claim 1, wherein the computing the value comprises computing a brightness value based on the image data.

7. The method of claim 1, further comprising determining a clarity of the camera device based on the brightness value.

8. A system for controlling an autonomous vehicle, comprising:
a non-transitory computer readable medium comprising:
a first module configured to, by a processor, receive image data from a camera device coupled to the autonomous vehicle;
a second module configured to, by a processor, compute a value based on the image data, and determine one of a cleanliness and an uncleanliness of the autonomous vehicle based on the computed value; and
a third module configured to, by a processor, selectively generate a signal to at least one of control the autonomous vehicle to navigate to a cleaning station and notify a user based on the determined one of cleanliness and uncleanliness of the autonomous vehicle.

9. The system of claim 8, wherein the second module computes a color value as the value based on the image data.

10. The system of claim 9, wherein the color value is a Red, Green, Blue value.

11. The system of claim 9, wherein the second module determines the at least one of the cleanliness and the uncleanliness of the autonomous vehicle based on a comparison of the color value to a stored value associated with a body of the vehicle.

12. The system of claim 8, wherein the second module computes the color value by computing a color value for a plurality of pixels in the image data, and wherein the second module determines the at least one of the cleanliness and the uncleanliness of the autonomous vehicle is based on a comparison of the color values for the plurality of pixels to a threshold.

13. The system of claim 8, wherein the second module computes a brightness value as the value based on the image data.

14. The system of claim 13, further a fourth module that determines a clarity of the camera device based on the brightness value.

15. A vehicle, comprising:
a plurality of camera devices distributed about the vehicle, the camera devices sense at least a portion of a body of the vehicle; and
a controller that is configured to, by a processor, receive image data from at least one of the camera devices, compute a value based on the image data, determine one of a cleanliness and an uncleanliness of the autonomous vehicle based on the computed value, and selectively generate a signal to at least one of control the autonomous vehicle to navigate to a cleaning station and notify a user based on the determined one of cleanliness and uncleanliness of the vehicle.

16. The vehicle of claim 15, wherein the controller computes a color value as the value based on the image data.

17. The vehicle of claim 16, wherein the color value is a Red, Green, Blue value.

18. The vehicle of claim 16, wherein the controller determines the one of the cleanliness and the uncleanliness of the autonomous vehicle is based on a comparison of the color value to a stored value associated with a body of the vehicle.

19. The vehicle of claim 15, wherein the controller computes a brightness value as the value based on the image data.

20. The vehicle of claim 15, wherein the controller determines a clarity of the camera device based on the brightness value.
